(19) United States
(12) Patent Application Publication
(10) Pub. No.: US 2013/0002887 A1
(43) Pub. Date: Jan. 3, 2013

(54) System And Method For Automated Set-Top Box Testing Via Configurable Event Time Measurements

(76) Inventor: Jeremy Bruce-Smith, Dublin (IR)

(21) Appl. No.: 13/512,323

(22) PCT Filed: Nov. 25, 2010
(86) PCT No.: PCT/EP2010/068264

§ 371 Date: Sep. 19, 2012

(30) Foreign Application Priority Data
Nov. 25, 2009 (GB) 0920647.5

(51) Int. Cl. H04N 17/04

(52) U.S. Cl. 348/189; 348/E17.005

(57) ABSTRACT

The present application provides a user configurable test system for the automatic detection of events on a set-top box (STB) and the determination of their timing. The system relies upon performing metric calculations on the A/V output of the STB and measuring the duration of the event by reference to a set of user defined metrics satisfying a set of user defined conditions. The system is particularly suited to zap time measurement

### FIELD

The invention pertains generally to the automated testing of set-top boxes (STB).

### BACKGROUND

A set-top box (STB) also known as a digibox or set-top unit (STU) is a device that connects to a television and an external source of signal, turning the signal into content which may then be delivered as an Audiovisual (A/V) signal for display on the television screen or other A/V device. Most frequently, the external source of signal is provided by a satellite or cable connection.

As with other consumer products, both manufacturers and suppliers are keen to ensure that products operate correctly and as specified. Initially and to this day, a significant part of the testing is performed manually, whereby a tester issues a command to the STB which may be via the user interface on the STB itself or via a remote control device as illustrated in FIG. 1, and observes the response of the STB on a TV display. As is shown in FIG. 1, a typical STB 10 has a number of signal inputs including an RF signal 14, which may for example be from a satellite or cable connection. An A/V signal 16 may also be provided as input allowing the set-top box to feed through a signal to a television from a VCR, DVD, Blu-ray disc, Media Juke Box or other similar device. The output to the television is an A/V signal 18 which may be provided over a variety of standard interfaces including SCART and HDMI. To allow the user control the operation of the STB, a number of buttons and similar controls may be provided on the STB itself. Additionally and more commonly employed by users, the STB may have an infra red (IR) or wireless remote control input configured to operate with a remote control device 12.

As manual testing can be time consuming, prone to error and in some instances lacking accuracy, an effort has been made to automate some of these tests. In respect of these automated tests, it will be appreciated that this testing is typically performed on the end product by users without necessarily any detailed knowledge or access to the internal circuitry of the STB. Accordingly, the testing of STB's is generally performed on a “black-box” basis, where only the inputs and outputs are available for modification and examination. Accordingly test methods and systems have been developed specifically for set top boxes, an example of such a system is shown in FIG. 2. The STB test system 20 comprises an output interface for controlling a remote control device 12, allowing commands to be sent to the STB and an input interface for receiving the video and/or audio signals from the STB 10. This input interface may include an audio capture device 24 for accepting the audio as a test signal and/or a frame grabber 22 or similar device for accepting the video frames from the STB. The data captured is then made available to a processor for analysis, which in turn produces a test result and provides this to a user. Thus during a typical test, the Test System issues a command or sequence of commands to the STB, suitably via the remote control interface. Each frame of video and/or the audio is captured and made to available to the Test System for analysis of the STB response to the commands issued to it.

Typically, tests might include the generation of a “change channel” command to the STB followed by analysis of the audio and/or video outputs to ensure that the channel change command was correctly received and executed by the STB. The present application is directed at providing an improved STB test system.

### SUMMARY

The present application is directed at measuring the time taken for an event to occur. Manual testing often includes some estimation of the time taken by the STB to execute a given command since this is an important parameter affecting the end-user's experience. For example, how long did it take to change channel (“zap time”) or how long did a banner dwell on the screen or how long did it take for the electronic programming guide (EPG) to appear or disappear. It will be appreciated that this time estimation is largely subjective.

Furthermore, the present inventors have appreciated that in some circumstances the STB response is highly variable as it dependent on the incoming signals which are typically conventional signals from a satellite dish or cable rather than locally generated test signals. Thus, for example, the time taken to change channel is typically a function of the current channel, the desired channel, and the relative time between the issue of the “change channel” command and the next I-frame in the video stream. The latter is essentially a random component since there is no synchronisation between the user's “button press” and the I-frames in the video stream. Generally a STB specification might include a “worst case” time i.e. the time taken to change between any two channels should never exceed a certain specification. However, the reality is that unless an STB is well outside specification, it is difficult to assess.

This present application provides a STB test system that includes a mechanism for measuring with reasonable precision the time taken for certain events to occur.

In particular, the present invention provides a STB test system and method for testing in accordance with the claims which follow.

Advantageously, the system and method allows for the measurement of a wide range of events e.g. time to change a channel (zap time), dwell time of a banner, time taken for EPG to appear/disappear, time taken to pause or re-start video content, duration of an audio alert, event synchronisation (between audio and video, for example).

### DESCRIPTION OF DRAWINGS

The present application will now be described with reference to the accompanying drawings in which:

FIG. 1 is an illustration of an exemplary STB known in the art,

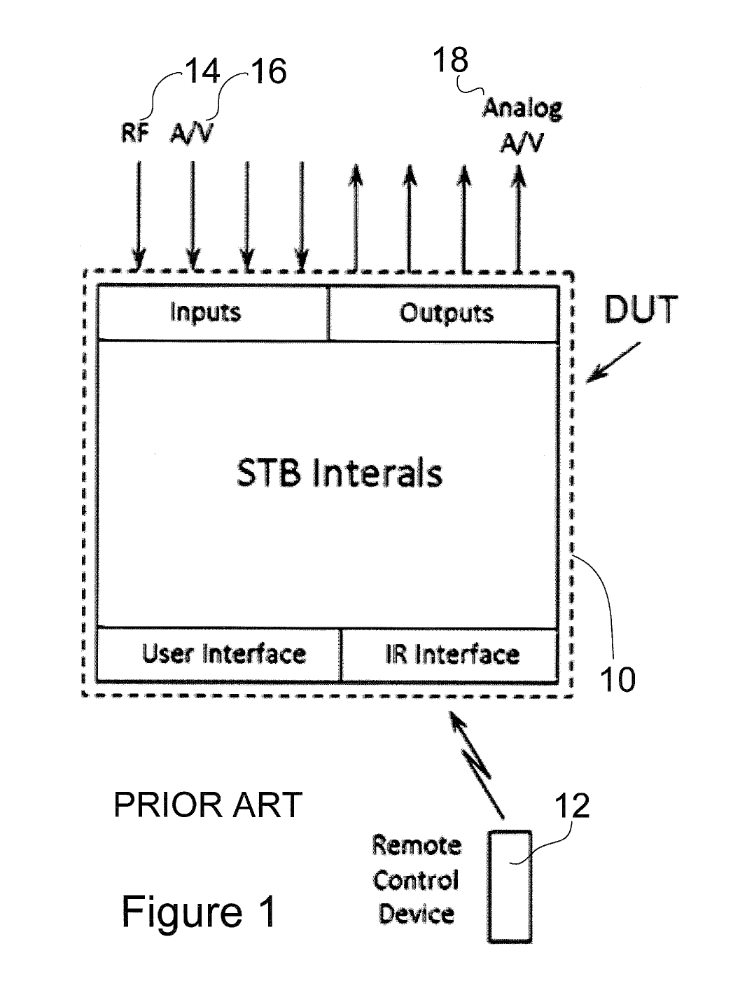

FIG. 2 is an illustration of a conventional prior art STB test system,

FIG. 3 is a block diagram of an aspect of STB test system according to an embodiment of the present application.

### DETAILED DESCRIPTION

The present application is based on the observation that many of the events being measured may be defined by the content in the whole or a particular part of each frame. For example when the user issues a “change channel” command to the STB the STB must interpret the command, re-tune to the new channel, await the next I-frame so that it can start decoding and display the new channel. In the interval between leaving one channel and being able to display the new channel the STB is unable to show either channel and therefore typically the user is presented with a screen of some predefined colour which may or may not contain some status information or other content. Exactly what is displayed, and how, will be specific to each STB. However, in the context of the present test system what is important is that the change is predictable in advance. If the change is predictable, then there is information that may be used in the definition of the automated test. However, since the test system are generally not intended to be STB specific it is beneficial that this feature be user configurable.

It should be pointed out that what is available to the tester is the video frames generated during the time taken to change channels. What the test system observes is conventionally a noisy version of this video content since the digital signal in the STB is typically converted back to analog before being sent to the A/V output and then re-converted back to digital in the frame grabber.

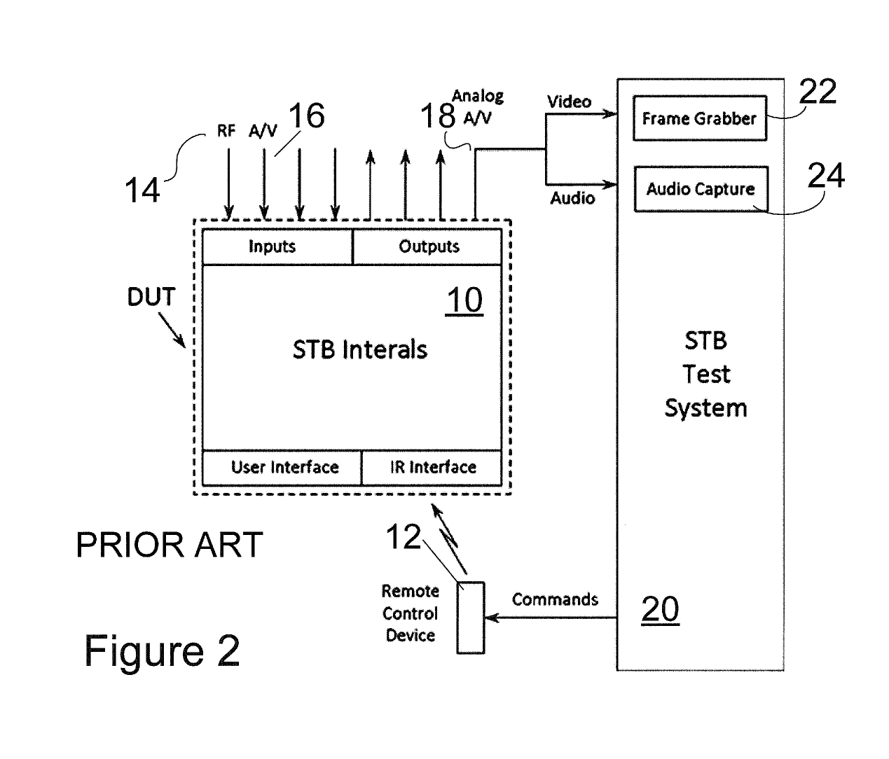

An exemplary test system for testing a STB may employ the generic STB test system of FIG. 2 and thus include a first interface for controlling the operation of a set-top box, for example by sending commands to the STB via an IR remote control. Although, it will be appreciated that other control inputs/interfaces may be employed for example a direct serial connection may be employed if the STB has such an interface available. It will be appreciated that an interface employed to control the STB is commonly employed in conventional test systems for STB's and thus their design and operation would be readily understood and familiar to those skilled in the art.

A second interface is employed to acquire one or more outputs from the STB. This second interface may include a frame grabber for capturing the video frames from the STB and/or an analog to digital converter for capturing the audio output from the STB. It will be appreciated that the technology associated with these elements would also be familiar to those skilled in the art. However, suitably the frame grabber is synchronised to the video frame timing allowing it to capture one complete video frame at a time. It will be appreciated that where a digital output is available from the set-top box, the requirement for an analog frame grabber/audio capture device may be obviated and replaced by a digital interface.

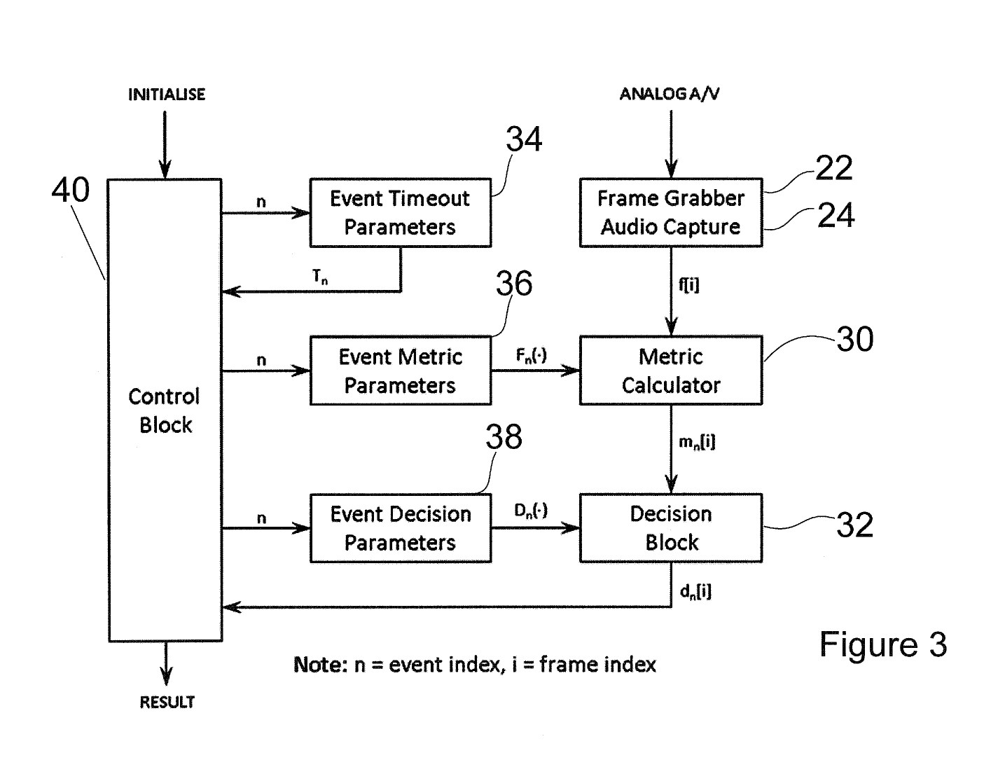

The substantive aspects of the exemplary embodiment comprises, as shown in FIG. 3, an analyser suitably made up of the metric calculator and decision block for analysing the acquired A/V signal to determine the occurrence of a predefined event. A control block functions, inter alia, as a timer for measuring the time taken between the issuance of a control signal and the determination of the occurrence of the predefined events by the analyser. In the arrangement of FIG. 3, the control block is also responsible for the generation of control signals for the first interface (not shown). It will be appreciated that the individual blocks may be implemented in software and/or hardware or a combination of both. The analyser may analyse the captured audio and/or video to determine the occurrence of a particular event. It may operate on video signals only or audio signals only or both video and audio signals

The operation of the timer and analyser will now be explained with reference to the more detailed blocks of FIG. 3.

The metric calculator 30 comprises a computational engine which computes metrics as defined by a user in terms of one or more parameters. In the case of video signals, these metrics may typically be evaluated once per frame. The event metric parameters 36 are predefined and specify what aspect of the video should be analysed. It will be appreciated that these metric definitions for each event may change between events in a sequence and/or between tests in a test sequence and accordingly are preset in accordance with the results expected to a particular control signal input to a STB. Thus, for example, the event metric may comprise the mean and standard deviation of each of the video components in specific areas in the video frame including the whole frame if so defined. The metric definitions may, and usually are, different for each event and are user configurable. The metric may be a vector of computed values of arbitrary length. For example, the mean and standard deviation of the Y, U, and V components calculated over a part or whole of the frame.

An event decision block 32 decides whether an event has occurred. The event decision block is directed by event decision parameters 38. The event decision parameters are user configurable parameters which define how the metrics are to be used to decide whether a given event has occurred or not. These parameters may include any combination of operators, variables and constants including vectors or more generally matrices. For example, the event decision parameters may specify the mean of the Y component is within 10% of some constant and standard deviation of Y component is less than 0.01 times the standard deviation of the Y component computed over the whole frame. Whilst, the decision block is typically configured to operate on a frame by frame basis based on predefined parameter settings, it may also contain memory. In such a configuration, decisions may be based on past metrics and/or past decisions. For example, performing a test to determine if the current metric is greater than a certain ratio of the previous metric, e.g. twice the value of the last metric.

The decision block employs the metrics as an input and applies the event decision parameters associated with the current event to make a decision on whether a new event has occurred or not. The decision block provides a signal back to the control block 40 indicating when a particular event has occurred. The control block generally initialises and controls the operation of the other blocks and keeps track of the event index. The control block performs the timing function by recording the time when event transitions occur and computing the time between event transitions. The control block provides the test results to the test system user, including event transition times, event duration, test status etc.

A particular advantage of the system is that a particular test can be repeated a number of times, for example 20 times, to provide an average time for an event, which would average out the error due to timing with reference to the occurrence of I-frames in the incoming video signal.

Whilst the function of the test system is to determine the occurrence of an event and its associated timing, it will be appreciated that in some circumstances the event may fail to occur. To prevent such a failure causing the test system to continue with a test indefinitely, the control block may include one or more timeout clocks. The durations of these clocks may be user configurable allowing a user to define how long should be waited for a event transition before timing out. Timeout parameters may be different for each event transition.

As illustrated in FIG. 3, the test system may be used to measure a sequence of events E₁, E₂, . . . , E_{N} rather than a single instance. This sequence is suitably defined by the user and the system determines some or all of the values t₁, t₂, . . . , t_{N}. Suitably, the user specifies the functions F₁(•), . . . , F_{N}(•) and D₁(•), . . . , D_{N}(•) so that the system may reliably detect the occurrence of a given event and/or the transition from one event to another given that some of the video and audio input may not change and that all of the video and audio content will suffer some degree of degradation in the transition from digital to analog and back to digital again.

TABLE 1
Explanation of parameters in FIG. 3

| Item | Definition and Description |
|---|---|
| i | Represents the frame index assuming values 1, 2, . . . where, |
| | without loss of generality, i = 0 is the index of the first frame to |
| | arrive after initialisation of the test. |
| n, N | n is the event index indicating the position in a test sequence and |
| | N is the total number of events specified in the test such that 1 ≦ n ≦ |
| | N. |
| Frame f[i] | Digital representation of the ith A/V frame. Typically f[i] will |
| | contain component video samples (e.g. YUV but more generally |
| | any video format) and component audio samples (e.g. right and |
| | left stereo channels but more generally any audio format) |
| Event, E | Any occurrence with an end time identifiable by analysis of A/V |
| | output. The start time may also be determined by analysis of the |
| | A/V output or it may be determined with reference to the |
| | transmission of a control signal to the STB. It will be appreciated |
| | that the use of an A/V output as a trigger for the start time, where |
| | the measurement of time is with respect to an intermediate step. |
| | For example, where a use sends a channel change signal to a STB, |
| | there are two stages the first typically is the initial response time to |
| | the user input whereupon a colour screen (e.g. blue) is displayed |
| | optionally with a banner and secondly the time involved in tuning |
| | and displaying the channel. It will be appreciated that both of |
| | these time intervals may be measured by the present system. The |
| | event may also be an audio input, for example, a beep sound |
| | defined by the presence of one or more tones in the audio stream. |
| | Or a banner display defined by the appearance of an overlay in |
| | some part of the screen. The test system may include a |
| | configuration interface allowing a user to specify inputs and |
| | events. The interface may be detailed, e.g. allow the user to specify |
| | a specific response in detail, e.g. a particular section of the screen |
| | to have a particular colour or it may allow more generic |
| | specifications, e.g. selections from drop down lists or the like, |
| | which are then translated by the system into specifics. These |
| | specifications may be defined positively and/or negatively. For |
| | example, “not a blue screen” or “absence of continuous single tone |
| | of a given frequency in audio output” |
| E₁, E₂, . . . , E_{N} | A sequence of N events defined by the user. For example, normal |
| | channel viewing (E₁) followed by blanked screen (E₂) followed by |
| | normal channel viewing (E₃). For mathematical convenience E₀ may |
| | also be defined and associated with initialisation. |
| T₁, T₂, . . . , T_{N} | Tₙ is the timeout for event Eₙ defined by the user. Exit for example |
| | if a transition to Eₙ₊₁ has not been observed within Tₙ time units of |
| | the start of Eₙ. These are not an essential feature of the invention |
| | and there are many ways to achieve the same purpose e.g. a global |
| | timeout for the test would also suffice. |
| t₁, t₂, . . . , t_{N} | tₙ is the time (relative to initialisation, for example) at which event |
| | Eₙ starts. Thus Eₙ starts at tₙ and finishes at tₙ₊₁. One of the goals of |
| | this invention is to determine some or all of the sequence of times |
| | t₁, t₂, . . . , t_{N}. For mathematical convenience, and without loss of |
| | generality, t₀ may be defined as zero. |
| Fₙ(·) | Collection of kₙ metric functions associated with the detection of |
| | an event, E_{n·} Fₙ(·) operates on any frame of data, f[i], or more |
| | generally any sequence of rₙ consecutive frames, f[i − rₙ + 1], . . . , f[i]. |
| | The output of Fₙ(·) is a vector of kₙ metrics. |
| mₙ[i] | Vector of kₙ metrics computed by Fₙ(·) operating on the frames f[i − |
| | rₙ − 1] to f[i] i.e. mₙ[i] = Fₙ(f[i − rₙ + 1], . . . , f[i]) |
| Dₙ(·) | Decision function associated with the event, Eₙ, which takes as |
| | input the metrics computed using Fₙ(·) |
| dₙ[i] | The result of the decision function Dₙ(·) applied to the metric |
| | vector associated with the ith frame i.e. mₙ[i]. Therefore, dₙ[i] = |
| | Dₙ(mₙ[i]). dₙ[i] may have several values such as “Eₙ not detected”, |
| | “Eₙ detected” and may include a measure of the “confidence” in |
| | the result. It may also contain other warning and/or error |
| | messages. |

TABLE 2
Explanation of blocks in FIG. 3

| Component Part | Description |
|---|---|
| A/V Frame | To be understood in its most general sense as any fixed duration |
| | of time. It may contain digital video and/or audio samples in any |
| | format. When the frame contains The usual frame duration will |
| | typically be an integral multiple of the video frame interval, T_{frame}. |
| Frame Grabber | Captures and converts to digital the audio and/or video data at |
| | the input and presents to the metric calculator in a suitable format. |
| Event Metric | Stores the user supplied definitions of each of the kₙ metric |
| Parameters | function which comprise the N functions Fₙ(·), 1 ≦ n ≦ N. For |
| | example, F₂(·) could be defined as the following functions: the |
| | mean and standard deviation of each of the Y, U, and V |
| | components of the video data to be found in the top right hand |
| | quarter of the current frame. The output of F₂(·) would then consist of |
| | these k₂ = 6 metrics. |
| Metric Calculator | Computes the metric vectors mₙ[i] for each new frame of data |
| | received. The definition of the metric function Fₙ(·) is obtained |
| | from the Event Metric Parameters block and the current event |
| | index, n, is supplied by the Control Block which tracks event |
| | transitions. A specific implementation of the system may limit |
| | the users choice in the number and definition of the metric functions |
| | e.g. operators, sub-functions etc. However, in principle the only |
| | restriction on the type of function that can be defined is |
| | computability to the desired accuracy within a reasonable amount of |
| | time using the hardware resources at hand. |
| Decision Metric | Stores the user supplied definitions of each of the decision |
| Parameters | functions Dₙ(·), 1 ≦ n ≦ N. Definitions may included functions, |
| | operators, constants etc. For example, D₂(·) could be defined as |
| | the follows: d₂[i] = “E₂ has started” if, for each of the Y, U, and V |
| | components of the video data associated with the top right hand |
| | quarter of the ith frame, the mean value is within ±P % of some |
| | constant Cₘₑₐₙ and the standard deviation is less than some |
| | constant, C_{sd}. Otherwise d₂[i] = “E₂ not yet started” |
| Decision Block | Applies the decision function Dₙ(·) to the metric vector mₙ[i] for |
| | each new frame of data received to give decision output, dₙ[i]. |
| | The definition of the decision function Dₙ(·) is obtained from the |
| | Event Decision Parameters block and the current event index, n, |
| | is supplied by the Control Block which tracks event transitions. A |
| | specific implementation of the system may limit the users choice |
| | in the number and definition of the metric functions e.g. |
| | operators, sub-functions etc. However, in principle the only |
| | restriction on the type of function that can be defined is |
| | computability to the desired accuracy within a reasonable |
| | amount of time using the hardware resources at hand. |
| Control Block | Controls all aspects of the test including initialisation, running, |
| | timeout, error handling, etc. Uses dₙ[i] to track event transition |
| | and computes start and end times of some or all events. Tracks |
| | current frame index and current event index and passes this and |
| | other required information to other blocks in the system. |
| | Presents timing results to the users. This block is also configurable |
| | by the user e.g. specify which event is to be timed, the number of |
| | times the test is to be run etc |

Whilst, the present application has been described generally above, it will now be explained in greater detail with reference to an exemplary measurement, namely that of “zap-time”. Zap time is the time it takes a set-top box to change channels. It will be appreciated that a key difficulty in measuring zap time is that each manufacturer of set-top boxes and indeed each model may employ a different intermediate stage during the transition between displaying the first channel and displaying the second channel. Moreover, even where the transition has occurred specific elements may continue to be displayed for a further duration, for example a banner displaying channel information.

However conventionally, there is always some form of stationary (non moving) screen, or part of the screen, to mask the actual channel change. Although, it will be appreciated that alternative approaches may be employed to mask a channel change including the display of textual information on the channel and/or advertising content. The previously described test system allows for the automatic detection of the transition into and out of this screen and hence allows for the possible measurement of zap time to an accuracy of one video frame.

As each STB may have a different method to mask the actual change, the advantage of the configurable system described above is that the user may customise/configure the method by which detection of events may be realised by a sequence of simple metrics on a video frame.

Being simple, these metrics may be calculated very quickly and thus the channel change time can measured in real time.

The (Video Frame) Metric Calculator may calculate one or more distinct metrics over one or more areas (suitably rectangles for convenience of calculation) within a video frame (a rectangle may be the entire frame).

Each of the metrics that are calculated are predetermined (preselected) by the STB tester. These metrics may be provided to the STB tester in the form of a predefined list during a test configuration process. Examples of metrics would include, but are not limited to:
count of distinct (YUV) colours present in the rectangle
count of distinct grouped (UV) colours
Arithmetic mean of a video component (e.g. Y, U or V)
Standard deviation of a video component (e.g. U or V)
Sum of arithmetic means of individual (Y, U and V) components
Sum of standard deviations of individual (Y, U and V) components

The output of the metric calculator is passed to the decision block component. This component compares the calculated metrics to predetermined threshold values predefined by the STB tester during a test configuration process. The comparison may in turn be selected from a predefined list of comparisons including, for example, but not limited to:
Greater than
Greater than or equal to
Less than
Less than or equal to
Increasing of
Decreasing of
% increase of
% decrease of
Change greater than
Change less than
% change greater than
% change less than

The decision block takes the value supplied by the metric calculator and applies the condition to that value in comparison with the predetermined threshold value. The threshold may either be an absolute number or a % depending on the condition. Except for the “Greater than”, “Less than”, “greater than or equal to” and “less than or equal to” conditions, the decision block uses the frame span to determine whether the condition has been met. For example, the STB tester could set up the decision block to look for a 5% increase in standard deviation of Y component over 4 frames—this means that a very slow gentle increase (of less than 1.25% per frame) would not be considered to ‘match the sequence’

For greater flexibility, the test system may allow for the measurement and comparison of more than one metric in a given test in a sequence. When two or more metrics are specified, the logical output of each one is combined by the decision block in a Boolean manner using the supplied Boolean combining operator, which may be selected from one of:
OR
AND
NOR
NAND
XOR
XNOR

In conducting a test, the control block starts at the start of the list defining a test sequence. It tells the Metric Calculator which metrics are to be calculated and which rectangles are to be used for each part of the test. Similarly, the control block directs the decision block on the nature of the decision to be made. Thus on each frame, the system applies the conditions, Boolean operator and timeout to determine whether the current frame matches the item in the list. If it does, the control block measures the time and proceeds to examine the next item in the list, informing the metric calculator and decision block of the revised metrics, thresholds and rectangles to use.

When the last item in the list is matched, the whole process ends and the control block may provide a report to a user, e.g. on a display, in a data file or on a print out, indicating the overall time and individual timings of events during the test sequence.

Advantageously, the system may be configured to allow a STB user to specify the number of times that individual tests in the sequence are to be repeated. The system may also allow a user to specify a generic test, e.g. a channel change (zap time) measurement, and the test system may be configured to repeat the test for different channel combinations. In this way, a STB test system may be configured to calculate an average time not only for a specific channel change but also to calculate an average time for every possible channel change configuration. It will be appreciated that this may involve a significant number of channels and thus combinations and thus the user may reduce the test time, e.g. by specifying the intervals between channel changes, e.g. only every 10^{th} channel be considered. Additionally, the system may also be configured to measure the event durations in response to externally (non-user) generated control signals. For example, control signals may be embedded within an A/V signal and the STB may be responsive to these. In this scenario, the test system may include an interface for receiving the A/V or indeed generating the A/V signal.

### Configurability

In most practical situations it is desirable that an automated test system such as that described above is STB agnostic i.e. it may be used to test a wide range of different STBs. To this end it is beneficial for such test systems to be script driven. In other words the test to be performed on a given STB is described to the system by means of a test script which the test system subsequently executes. The test script determines what commands are issued to the STB, their sequence, and details how the outputs of the STB are to be monitored to ensure that it conforms with the expected result. An important aspect of this application is that it is user configurable. The user defines the commands to be issued by the system and the sequence of events to be analysed. The user may also define how the start and end of each event is to be recognised and what decision functions and metrics are to be used by the test system to determine whether or not a new event has occurred. It will be appreciated by anyone skilled in the art that there are many ways to achieve this. At a high level the test system may include large choice of pre-defined high level functions with a single parameter indicating the STB to be tested. For example “MeasureZapTime(Ch1, Ch2, STB_ID)” where STB_ID identifies to the system the type of STB to be tested and the MeasureZapTime( ) function uses a predefined sequence of events with associated metric and decision functions to measure the zap time between channel Ch1 and channel Ch2. At a lower level the test system may offer a range of functions such as “EventDefinition(n, x1, y1, x2, y2,“abs(mean(Y)−Cy)”, “abs(mean(U)−Cu)”, “abs(mean(V)−Cv)”, “(M1<0.1) AND (M2<0.1) AND (M3<0.3)”, Tn) which would be interpreted by the system as follows: After event (n−1) has been detected the rectangle in each subsequent frame defined by the xy coordinates (x1,y1) and (x2,y2) is analysed and three metrics (M1, M2, M3) are computed as the mean of each of the YUV components respectively less a specified constant. Event n is deemed to have occurred if (M1<0.1) AND (M2<0.1) AND (M3<0.3) is true. The function then returns the frame index of the first frame in which event n is deemed to have occurred. Otherwise, the function returns a “not found” result Tn seconds after the start of event (n−1).

In another implementation the test can be defined by the user via a graphical user interface (GUI) wherein the events and associated metric and function definition can be filled in as fields on a form or using pull-down menus or a combination of both. In such cases it is usual for the GUI to parse the user supplied fields and parameter selections and subsequently generate the corresponding script or code to be executed during the test.

Whilst the present application has been described generally with reference to an exemplary system, it will be appreciated that a variety of modifications and alterations may be made without the departing from the spirit and scope of the present invention. Thus for example, whilst the present application has been described generally with respect to STB's it will be appreciated that it may be employed with a wide variety of A/V equipment.

Moreover, it will be further appreciated that with the convergence of technologies, the functionality of STB's may be incorporated within other devices, such as televisions and thus the scope of the present application is intended to include test systems for these generally albeit that in some circumstances an A/V output may not be available directly and an additional element, for example a video camera, may be required to capture the video signal in such devices.

Advantageously, the presently described system and method allows for the measurement of a wide range of events e.g. time to change a channel (zap time), dwell time of a banner, time taken for EPG to appear/disappear, time taken for popup banners or menus to appear/disappear, time taken to start, pause, or restart playback video content from local or network sources, duration of an audio alert, event synchronisation (between audio and video, for example). It will also be appreciated that the system and method can be used to measure timing differences for this same range of events, between different hardware and software versions of the same product, thus ensuring that deviations from specification are not inadvertently introduced by hardware or software updates.

1. An automated test system for a set-top box, comprising:
a first interface for providing control signals to a remote control input of a set-top box under testing;
a second interface for acquiring a video output signal from the set-top box;
an analyser for analysing frames of the acquired video output signal to determine a completion of at least one event according to at least one predefined metric; and
a timer for measuring a duration of the at least one event.

2. An automated test system according to claim 1, wherein the timer is configured to measure the duration of the at least one event by counting a number of the frames arriving during the at least one event.

3. A test system according to claim 1, wherein the timer measures a start of the at least one event as a time of issuance of one of the control signals from the first interface.

4. A test system according to claim 1, wherein the analyser analyses the acquired video output signal to determine an occurrence of at least two events with a completion of one of the two events marking a start of the other of the two events.

5. A test system according to claim 1, wherein a sequence of individual tests are performed and at least one event duration is measured for at least one individual test in the sequence.

6. A test system according to claim 1 wherein the at least one event is defined by a user and the analyser employs one or more user defined rules to determine the occurrence of the events which are configurable by the user.

7. A test system according to any claim 1 wherein a zap time of the set-top box is measured.

8. A test system for a set-top box according to claim 1, further comprising;
a controller for controlling operation of the first interface and the analyser.

9. A test system according to claim 8, wherein functionality of the timer is incorporated into the controller.

10. A test system according to claim 8, wherein the controller is configured to conduct a sequence of tests on the set-top box, with each test in the sequence having one or more predefined metrics for marking an end of the at least one event within that test.

11. A test system according to claim 8, wherein the controller is configured to determine if the duration of the at least one event has exceeded a predetermined limit set for the event.

12. A test system according to claim 11, wherein an error message is generated and sent to a user when the event duration exceeds the predetermined limit.

13. A test system according to claim 11, wherein the controller proceeds with a next test in the sequence when an event duration exceeds the predetermined limit.

14. A test system according to claim 1, wherein the analyser comprises a metric calculator for calculating a metric from the acquired video output signals.

15. A test system according to claim 14, wherein the calculated metric is a predefined measurement of content in a predefined area of a frame.

16. A test system according to claim 15, wherein the predefined area of the frame is an entire frame.

17. A test system according to claim 15, wherein the predefined measurement comprises at least one of a count of distinct video values present, an arithmetic mean of a component video value, a standard deviation of the component video value, a sum of arithmetic means of individual components, or a sum of standard deviations of individual components.

18. A test system according to claim 17, wherein the frames are in a YUV format.

19. A test system according to claim 1, wherein the video output signals acquired by the second interface are digital.

20. A test system according to claim 1, wherein the video output signals acquired by the second interface are analog.

21. A test system according to claim 1, wherein the first interface provides the control signals by means of a remote control.

22. A method for testing a set-top box, the method comprising:
providing control signals to a remote control input of a set-top box under testing;
acquiring a video output signal from the set-top box;
analysing frames of the acquired video output signal to determine a completion of at least one event according to at least one predefined metric; and
measuring a duration of the at least one event.

23. A method according to claim 22, wherein the duration of the at least one event is measured by counting a number of the frames arriving during the at least one event.

24. A method according to claim 22, wherein the acquired video output signal is analysed to determine an occurrence of at least two events with a completion of one of the two events marking a start of the other of the two events.

25. A method according to claim 22, further comprising:
performing a sequence of individual tests; and
measuring at least one event duration for at least one individual test in the sequence.

26. A method according to claim 22, wherein the at least one event is defined by a user and an analysis employs one or more user defined rules to determine an occurrence of the events which are configurable by the user.
